(19) United States
(12) Patent Application Publication
(10) Pub. No.: US 2017/0138287 A1
(43) Pub. Date: May 18, 2017

(54) CONTROLLING AN ENGINE SPEED OF A WORK VEHICLE

(71) Applicant: Deere-Hitachi Construction Machinery Corp., Kernersville, NC (US)

(72) Inventors: Shawn William Faris, LeClaire, IA (US); Nathan Joseph Livingston, Dubuque, IA (US)

(21) Appl. No.: 14/943,786

(22) Filed: Nov. 17, 2015

(51) Int. Cl. F02D 41/10

(52) U.S. Cl. CPC F02D 41/107; F02D 2200/021

(57) ABSTRACT

An engine speed of work vehicle can be controlled automatically based on various conditions. For example, an excavator can include a first sensor for detecting a vehicle characteristic and transmitting an associated first sensor signal, and a second sensor for detecting an engine characteristic and transmitting an associated second sensor signal. The excavator can include a control circuit for receiving the sensor signals. The control circuit can determine the vehicle characteristic based on the first sensor signal and the engine characteristic based on the second sensor signal. The control circuit can determine that at least one vehicle condition of multiple vehicle conditions is satisfied based on the vehicle characteristic, and that at least one engine condition of multiple engine conditions is satisfied based on the engine characteristic. The control circuit can transmit a signal configured to cause the excavator to reduce an engine speed to a low idle engine speed.

### TECHNICAL FIELD

The present disclosure relates generally to engine speed control. More specifically, but not by way of limitation, this disclosure relates to controlling an engine speed of a work vehicle.

### BACKGROUND

A work vehicle can be used for various construction tasks. For example, an excavator can be used to dig trenches or holes, handle materials, demolish structures, or cut through materials. But work vehicles can consume a large amount fuel while in use. Such fuel consumption can be costly for owners and operators of work vehicles.

### SUMMARY

In one example, an excavator is provided. The excavator can include a first sensor configured to detect a vehicle characteristic and transmit a first sensor signal associated with the vehicle characteristic. The excavator can include a second sensor configured to detect an engine characteristic and transmit a second sensor signal associated with the engine characteristic. The excavator can include a control circuit. The control circuit can be positioned in the excavator for receiving the first sensor signal from the first sensor and the second sensor signal from the second sensor. The control circuit can be positioned for determining the vehicle characteristic based on the first sensor signal and the engine characteristic based on the second sensor signal. The control circuit can be positioned for determining that at least one vehicle condition of multiple vehicle conditions is satisfied based on the vehicle characteristic. The multiple vehicle conditions can include an input device not being manipulated for a period of time, an ambient temperature of an environment within the excavator being with a first range of temperatures, another ambient temperature of another environment external to the excavator being within a second range of temperatures, a fan speed being with a first range of speeds, a power source voltage being within a range of voltages, or any combination of these. The control circuit can be positioned for determining that at least one engine condition of multiple engine conditions is satisfied based on the engine characteristic. The multiple engine conditions can include an engine temperature being within a third range of temperatures, an engine coolant temperature being within a fourth range of temperatures, and an engine speed being with a second range of speeds. The control circuit can be positioned for transmitting a signal configured to cause the excavator to reduce a speed of the engine to a low idle engine speed.

In another example, a method for controlling an engine speed of an excavator is provided. The method can include receiving a first sensor signal from a first sensor. The first sensor signal can indicate a vehicle characteristic of the excavator. The method can include determining that at least one vehicle condition of multiple vehicle conditions is satisfied based on the vehicle characteristic. The multiple vehicle conditions can include an input device not being manipulated for a period of time, an ambient temperature of an environment within the excavator being with a first range of temperatures, another ambient temperature of another environment external to the excavator being within a second range of temperatures, a fan speed being with a first range of speeds, a power source voltage being within a range of voltages, or any combination of these. The method can include receiving a second sensor signal from a second sensor. The second sensor signal can indicate an engine characteristic of the excavator. The method can include determining that at least one engine condition of multiple engine conditions is satisfied based on the engine characteristic. The multiple engine conditions can include an engine temperature being within a third range of temperatures, an engine coolant temperature being within a fourth range of temperatures, the engine speed being with a second range of speeds, or any combination of these. The method can include transmitting a signal configured to cause the excavator to reduce the engine speed to a low idle engine speed.

In another example, an engine speed control system for use in an excavator is provided. The engine speed control system can include a vehicle control circuit. The vehicle control circuit can be for determining that at least one vehicle condition of multiple vehicle conditions is satisfied. The multiple vehicle conditions can include an input device not being manipulated for a period of time, an ambient temperature of an environment within the excavator being with a first range of temperatures, another ambient temperature of another environment external to the excavator being within a second range of temperatures, a fan speed being with a first range of speeds, a power source voltage being within a range of voltages, or any combination of these. The vehicle control circuit can be for transmitting a first signal to indicating that the at least one vehicle condition is satisfied. The engine speed control system can include an engine control circuit. The engine control circuit can be for receiving the first signal. The engine control circuit can be for, in response to the first signal, determining that at least one engine condition of multiple engine conditions is satisfied. The multiple engine conditions can include an engine temperature being within a third range of temperatures, an engine coolant temperature being within a fourth range of temperatures, an engine speed being with a second range of speeds, or any combination of these. The engine control circuit can be for, in response to the first signal, transmitting a second signal configured to cause the excavator to reduce the engine speed to a low idle engine speed.

### BRIEF DESCRIPTION OF THE DRAWINGS

FIG. 1 is a side perspective view of an example of a work vehicle including a system for controlling an engine speed of the work vehicle according to some aspects.

FIG. 2 is a block diagram of an example of a system for controlling an engine speed of a work vehicle according to some aspects.

FIG. 3 is a flow chart of an example of a process for controlling an engine speed of a work vehicle according to some aspects.

FIG. 4 is a graph of an example of an engine speed of a work vehicle over a period of time according to some aspects.

### DETAILED DESCRIPTION

Certain aspects and features of the present disclosure relate to a system for controlling an engine speed of a work vehicle, such as an excavator. The work vehicle can be operable in one or more fuel saving modes. For example, the work vehicle can be operated in a normal idle mode, a low idle mode, or both. The work vehicle can switch between the fuel saving modes in response to detecting that certain vehicle conditions, certain engine conditions, or both are met. For example, the work vehicle can enter the low idle mode in response to determining that at least two vehicle conditions are met and at least two engine conditions are met.

In some examples, the work vehicle can reduce the engine speed of the work vehicle (e.g., to below a normal operating engine speed) in response to entering a fuel saving mode. For example, a normal operating engine speed of the work vehicle can be between 1700 revolutions per minute (rpm) and 2200 rpm. In response to entering the low idle mode, the work vehicle can reduce the engine speed to between 500 rpm and 900 rpm. In some examples, the reduced engine speed can cause the work vehicle to consume less fuel, which can provide cost savings to an owner or operator of the work vehicle.

It can be typical for an operator of a work vehicle to leave the engine of the work vehicle running, even while the operator is not using the work vehicle. For example, the work vehicle operator can use the work vehicle to perform a particular job at a construction site and, once the job is complete, keep the work vehicle running. The work vehicle operator may leave the work vehicle running to save time when the work vehicle is later needed. But as the work vehicle continues to run without performing any tasks, the work vehicle can consume a significant amount of fuel. Such fuel consumption can be costly for the owner or operator of the work vehicle. Some examples can implement one or more fuel saving modes to reduce fuel consumption of the work vehicle while the work vehicle is not in use.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

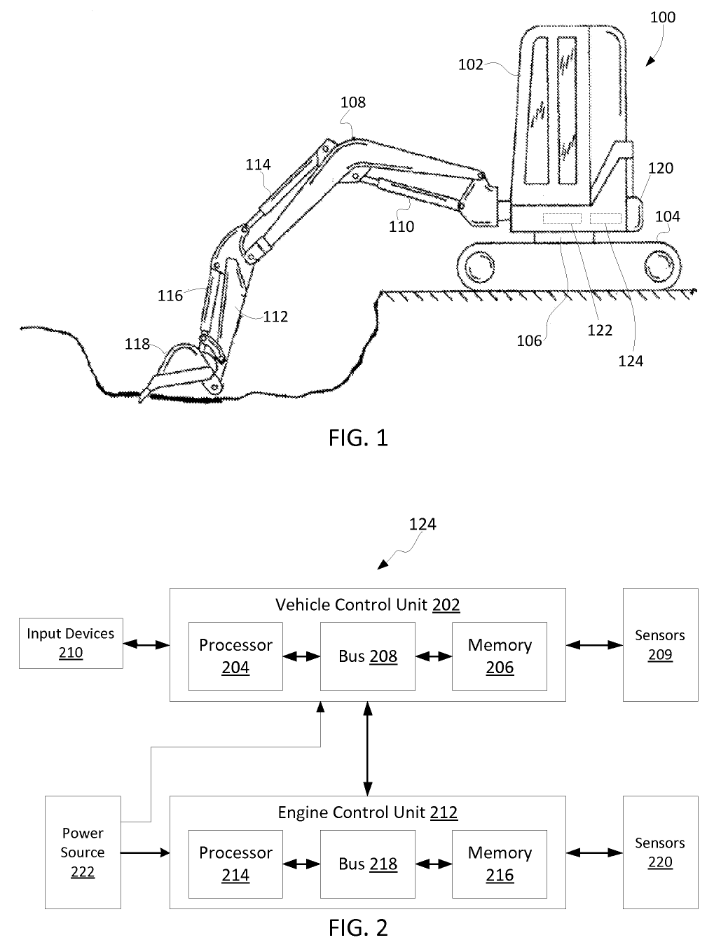

FIG. 1 is a side perspective view of an example of a work vehicle including a system for controlling an engine speed of the work vehicle according to some aspects. In this example, the work vehicle 100 includes an excavator. In other examples, the work vehicle 100 can include other vehicles, such as a truck, backhoe loader, bulldozer, harvester, paver, etc.

The work vehicle 100 can include a cab 102. The cab 102 can include a control system for operating the work vehicle 100. In some examples, the control system can include one or more levers, wheels, knobs, buttons, pedals, joysticks, or other input devices.

The work vehicle 100 can include an undercarriage. The undercarriage can be positioned beneath the cab 102. The undercarriage can include a movement device 104 for providing mobility to the work vehicle 100. In the example shown in FIG. 1, the movement device 104 includes a track system. The track system can include one or more tracks positioned either side of the undercarriage. In other examples, the movement device 104 can additionally or alternatively include wheels.

In some examples, the cab 102 can be positioned on an upper frame rotatably coupled to the undercarriage by a pivot device 106, such as a swing pivot. The pivot device 106 can allow the upper frame to rotate with respect to the undercarriage. In some examples, the pivot device 106 can allow the upper frame to rotate 360° with respect to the undercarriage.

The work vehicle 100 can include a boom 108. The boom 108 can be positioned adjacent to or in front of the cab 102. The boom 108 can be controlled by one or more hydraulic cylinders 110. For example, an operator of the work vehicle 100 can use the control system to operate the hydraulic cylinder 110, which can in turn move the boom 108. In some examples, the boom 108 can include a dipper stick or arm 112. The arm 112 can be controlled by one or more hydraulic cylinders 114. For example, the work vehicle operator can use the control system to operate the hydraulic cylinder 114, which can in turn move the arm 112. In some examples, a bucket 118 (e.g., an excavator bucket) can be positioned at an end of the arm 112. The bucket 118 can be movable with respect to the arm 112. For example, the bucket 118 can be pivotable with respect to the arm 112. The bucket 118 can be controlled by one or more hydraulic cylinders 116. For example, the work vehicle operator can use the control system to operate the hydraulic cylinder 116, which can in turn move the bucket 118.

In some examples, the work vehicle 100 can include a counterweight 120 for offsetting a load. The load can include, for example, a material positioned in the bucket 118. In some examples, the counterweight 120 can help balance the work vehicle 100 as the work vehicle 100 gathers the load.

The work vehicle 100 can include an engine 122. The engine 122 can control operation of the movement device 104. For example, the engine 122 can provide energy for moving a track of the movement device 104. The engine 122 can be controlled by the control system positioned in the cab 102. For example, a work vehicle operator can use the control system to operate the engine 122 for moving the work vehicle 100 in one or more directions.

In some examples, the work vehicle operator may leave the engine 122 of the work vehicle 100 running, even though the work vehicle operator may not be using the work vehicle 100. For example, the work vehicle operator can use the work vehicle 100 to perform a particular job or task at a construction site. Once the job is complete, the work vehicle operator may leave the work vehicle 100 (e.g., the engine 122) running for a period of time until the work vehicle 100 is again needed to perform another job. The work vehicle operator may leave the work vehicle 100 running to save time when the work vehicle 100 is later needed. But as the work vehicle 100 runs without performing any tasks, the work vehicle 100 can consume a significant amount of fuel. Such fuel consumption can be costly for the owner or operator of the work vehicle 100. It can be desirable to reduce such fuel consumption costs. In some examples, a system 124 can be implemented for controlling a speed of the engine 122 of the work vehicle 100. The system 124 can help reduce the fuel consumption of the engine 122, as described in greater detail with respect to FIGS. 2-4.

FIG. 2 is a block diagram of an example of a system 124 for controlling an engine speed of a work vehicle according to some aspects. The system 124 can include a vehicle control unit 202 for controlling operation of the work vehicle. The vehicle control unit 202 can include a vehicle control circuit. The vehicle control unit 202 (e.g., the vehicle control circuit) can include a processor 204, a memory 206, and a bus 208.

The processor 204 can execute one or more operations for controlling the engine speed of the work vehicle. The processor 204 can execute instructions stored in the memory 206 to perform the operations. A processor (e.g., processor 204) can include one processing device or multiple processing devices. Non-limiting examples of a processor include a Field-Programmable Gate Array (“FPGA”), an application-specific integrated circuit (“ASIC”), a microprocessor, etc. In some examples, a processor can include an arithmetic logic unit (ALU) for performing arithmetic operations and logic operations, one or more registers for supplying operands to the ALU and storing the result of an ALU operation, a control unit for fetching instructions stored in memory (e.g., memory 206) and executing the instructions, a clock or crystal for providing timing information to the processor, one or more capacitors (e.g., for stabilizing a current or voltage provided to the processor), one or more transistors, or any combination of these.

The processor 204 can be communicatively coupled to the memory 206 via the bus 208. The non-volatile memory 206 may include any type of memory device that retains stored information when powered off. Non-limiting examples of the memory 206 include electrically erasable and programmable read-only memory (“EEPROM”), flash memory, or any other type of non-volatile memory. In some examples, at least some of the memory 206 can include a medium from which the processor 204 can read instructions. A computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which the processor 204 can read instructions. The instructions can include processor-specific instructions generated by a compiler or an interpreter from code written in any suitable computer-programming language, including, for example, C, C++, C#, Java, etc.

In some examples, the vehicle control unit 202 can include other circuitry components. For example, the vehicle control unit 202 can include a resistor, capacitor, inductor, integrated circuit, crystal, transistor, tube, switch, relay, diode, transformer, one or more additional processors, memories, or busses, or any combination of these.

The vehicle control unit 202 can be electrically coupled to at least one input device 210. Examples of the input device 210 can include a lever, wheel, knob, button, pedal, joystick, or other input device. The input device 210 can be configured to be manipulated by a work vehicle operator's hand, foot, or other body part. The input device 210 can transmit one or more signals associated with a manipulation of the input device 210 to the vehicle control unit 202. The vehicle control unit 202 can receive the one or more signals and perform one or more functions based on the signals. For example, the vehicle control unit 202 can cause the work vehicle to move in a particular direction or can operate a working tool (e.g., a bucket, blade, arm, or boom) based on a signal from the input device 210.

In some examples, the input device 210 can include a power mode selector switch. The power mode selector switch can be positioned in a cab of the work vehicle. The power mode selector switch can be manipulated by the work vehicle operator for selecting a power mode from among at least two power mode options. For example, the power mode options can include a high power mode, a power mode, and an economy mode. In some examples, the input device 210 can include a control lever. The control lever can be positioned in the cab of the work vehicle. The control lever can be manipulated by the work vehicle operator for controlling an aspect of the work vehicle. For example, the control lever can be manipulated by the operator for controlling movement of the work vehicle or for controlling a working tool of the work vehicle.

The vehicle control unit 202 can be electrically coupled to one or more sensors 209. The sensor(s) 209 can detect various characteristics of the work vehicle and transmit sensor signals associated with the various characteristics to the vehicle control unit 202. For example, the sensor(s) 209 can detect a temperature of an environment internal or external to the work vehicle; a temperature of a particular work vehicle component, like the engine; or another temperature. Additionally or alternatively, the sensor(s) 209 can detect a pressure of an environment internal to the work vehicle; a pressure of an environment external to the work vehicle; a pressure associated with a manipulation of an input device 210; a pressure associated with a fluid, such as oil or a hydraulic fluid; or another pressure. Additionally or alternatively, the sensor(s) 209 can detect a fluid flow or a fluid flow direction, such as a flow direction of a hydraulic fluid. Additionally or alternatively, the sensor(s) 209 can detect an electrical voltage or an electrical current, such as an electrical voltage or an electrical current from a power source 222 of the work vehicle, respectively. Additionally or alternatively, the sensor(s) 209 can detect a speed of a fan of the work vehicle. The vehicle control unit 202 can receive the sensor signals from the sensor(s) 209 and perform one or more functions based on the sensor signals.

The system 124 can include an engine control unit 212. The engine control unit 212 can be coupled to the vehicle control unit 202 by a wired or wireless communication link. The engine control unit 212 can include an engine control circuit. The engine control unit 212 (e.g., the engine control circuit) can include a processor 214, a memory 216, and a bus 218. The memory 216 can store instructions executable by the processor 214 for controlling a speed of a work vehicle. In some examples, the processor 214, memory 216, and bus 218 can have any of the characteristics described above with respect to the processor 204, memory 206, and bus 208, respectively.

In some examples, the engine control unit 212 can include other circuitry components. For example, the engine control unit 212 can include a resistor, capacitor, inductor, integrated circuit, crystal, transistor, tube, switch, relay, diode, transformer, one or more additional processors, memories, or busses, or any combination of these.

The engine control unit 212 can be electrically coupled to one or more sensors 220. The sensor(s) 220 can detect various characteristics of an engine of the work vehicle and transmit sensor signals associated with the various characteristics to the engine control unit 212. For example, the sensor(s) 220 can detect an engine speed of the engine, a temperature of the engine, a temperature of an engine coolant, an oil pressure, or any combination of these. The engine control unit 212 can receive sensor signals from the sensor(s) 220 and perform one or more functions based on the sensor signals.

In some examples, the vehicle control unit 202, the engine control unit 212, or both can be electrically coupled to a power source 222, such as a battery. The power source 222 can transmit power to the vehicle control unit 202, the engine control unit 212, or both. The power source 222 can additionally or alternatively transmit power to other electrical devices of the work vehicle.

In some example, the system 124 may not include the engine control unit 212. In such an example, the sensors 220 can be electrically coupled to the vehicle control unit 202. In other examples, the system 124 may not include the vehicle control unit 202. In such an example, the sensors 209 and input devices 210 can be electrically coupled to the engine control unit 212. In some examples, the system 124 can include a control unit (e.g., a control circuit) that includes both the vehicle control unit 202 and the engine control unit 212. The system 124 can include any number and configuration of processors, memories, busses, control units, sensors, power sources, and input devices.

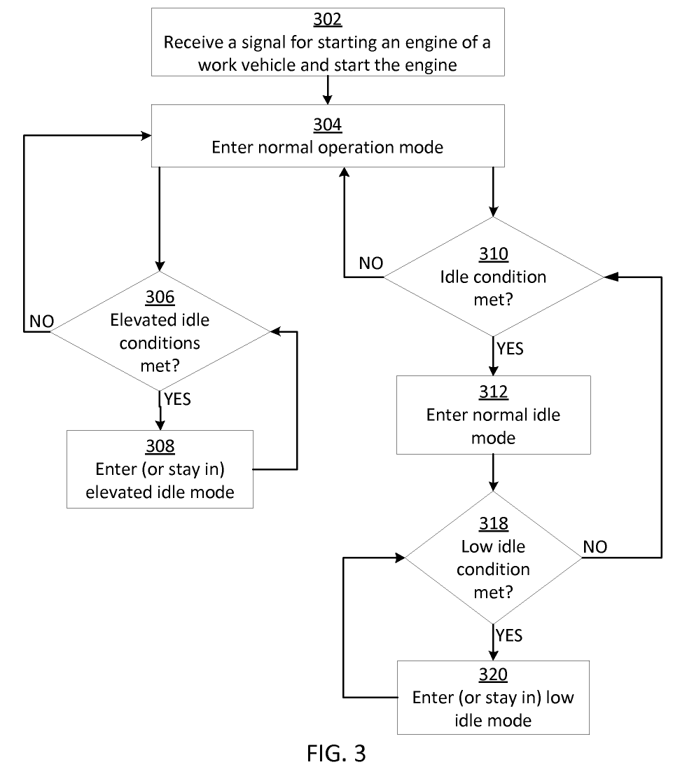

FIG. 3 is a flow chart of an example of a process for controlling an engine speed of a work vehicle according to some aspects. Some examples can include more, fewer, or different steps than the steps depicted in FIG. 3. The steps below are described with reference to the components described above with regard to the vehicle control unit 202 and the engine control unit 212 of FIG. 2.

In block 302, the work vehicle receives a signal for starting an engine of the work vehicle and starts the engine. In some examples, the work vehicle can receive the signal from an ignition of the work vehicle. For example, a work vehicle operator can turn a key in the ignition to start the work vehicle. In other examples, the work vehicle can receive the signal from an input device of the work vehicle. For example, a work vehicle operator can press a button (e.g., a start button), such as a button located in a cab of the work vehicle, to start the work vehicle. The work vehicle can receive the signal and responsively start the engine of the work vehicle.

In block 304, the work vehicle enters a normal operation mode. The work vehicle can enter the normal operation mode in response to detecting that one or more normal operation mode conditions are met. For example, the vehicle control unit 202 can receive a sensor signal from a sensor 209 indicative of a characteristic of the work vehicle, a sensor signal from an input device 210 indicative of user input, or both. The vehicle control unit 202 can analyze the characteristic of the work vehicle, the user input, or both to determine if the one or more normal operation mode conditions are met. If so, the vehicle control unit 202 can enter the normal operation mode. In some examples, the vehicle control unit 202 can change a speed of the engine to a normal operation speed in response to entering the normal operation mode. For example, the vehicle control unit 202 can transmit a signal to the engine control unit 212 configured to cause the engine control unit 212 to change the speed of the engine to the normal operation speed. In some examples, the normal operation speed can be between 1700 revolutions per minute (rpm) and 2200 rpm.

In some examples, a normal operation mode condition can include the work vehicle performing a work task, a user manipulating an input device 210, or both. For example, the vehicle control unit 202 can cause the work vehicle to enter the normal operation mode in response to determining a work vehicle operator has manipulated an input device 210 (e.g., a control lever or pedal). The vehicle control unit 202 can determine that the work vehicle operator manipulated the input device 210 based on one or more sensor signals from the input device 210.

In block 306, the work vehicle can determine if one or more elevated idle condition(s) are met. For example, the vehicle control unit 202 can receive one or more sensor signals from one or more sensors 209 indicative of one or more characteristics of the work vehicle. The vehicle control unit 202 can analyze the characteristics of the work vehicle to determine if the one or more elevated idle mode conditions are met.

In some examples, an elevated idle mode condition can include a temperature of the engine being above or below a threshold. For example, the engine control unit 212 can detect the temperature of the engine via one or more temperature sensors. The engine control unit 212 can determine that the elevated idle mode condition is met in response to determining that the temperature of the engine is below the threshold. The temperature of the engine being below the threshold may indicate that the engine needs to warm up.

In some examples, an elevated idle mode condition can include a particular status of a regeneration process. Regeneration can be a process of removing accumulated debris from a filter, such as a diesel particulate filter. For example, the engine control unit 212 can detect that the regeneration process is about to begin or has begun based on one or more system flags stored in memory 216. The engine control unit 212 can determine that the elevated idle mode condition is met in response to determining that the regeneration process is about to begin or has begun.

If the engine control unit 212 determines that the one or more elevated idle more condition(s) are met, the process can proceed to block 308. Otherwise, the process can proceed to block 304 and the work vehicle can remain in, or enter, the normal operation mode. The work vehicle can continuously check to determine if the one or more elevated idle mode condition(s) are met.

In block 308, the work vehicle enters (or stays in) the elevated idle mode. In some examples, the engine control unit 212 can change a speed of the engine to an elevated idle speed in response to entering the elevated idle mode. For example, the engine control unit 212 can transmit a signal configured to change the speed of the engine to the elevated idle speed. In some examples, the elevated idle speed can be between 1300 rpm and 1600 rpm.

In some examples, while in the elevated idle mode, the engine control unit 212 can continuously check to determine if the one or more elevated idle mode condition(s) are still met. If so, the engine control unit 212 can keep the work vehicle in the elevated idle mode. Otherwise, the engine control unit 212 can return the work vehicle to the normal operation mode.

While in the normal operation mode, the work vehicle can additionally or alternatively determine if an idle condition is met in block 310. In some examples, the work vehicle can determine that the idle condition is met if a current mode of the work vehicle is the normal operation mode. The work vehicle can additionally or alternatively determine that the idle condition is met if the work vehicle is not being used to perform active work. The work vehicle can additionally or alternatively determine that the idle condition is met if a coolant temperature for an engine of the work vehicle is within a predesignated range of temperatures. The work vehicle can additionally or alternatively determine that the idle condition is met if a voltage of a power source is within a predesignated range of voltages. The work vehicle can additionally or alternatively determine that the idle condition is met if an ambient temperature external to the work vehicle is within a predesignated range of temperatures. The work vehicle can additionally or alternatively determine that the idle condition is met if an input device 210 is not being manipulated by a work vehicle operator.

In some examples, if the idle condition is not met, the process can return to block 304 and the work vehicle can remain in the normal operation mode. Otherwise, the process can proceed to block 312.

In block 312, the work vehicle enters a normal idle mode. In some examples, the vehicle control unit 202 can change a speed of the engine to a normal idle speed in response to entering the normal idle mode. For example, the vehicle control unit 202 can transmit a signal to the engine control unit 212 configured to cause the engine control unit 212 to change the speed of the engine to the normal idle speed. In some examples, the normal idle speed can be between 800 rpm and 1500 rpm.

In some examples, while in the normal idle mode (block 312), the work vehicle can determine if a low idle condition is met in block 318. The work vehicle can determine that the low idle condition is met in response to determining that any combination of vehicle conditions, engine conditions, or both are satisfied.

In some examples, a vehicle condition can include an input device 210 not being manipulated for a period of time. For example, a vehicle condition can include a power mode selector switch having not been manipulated for a first period of time (e.g., 10 seconds), a control lever having not been manipulated for a second period of time (e.g., 150 seconds), a dial (e.g., an engine speed dial) having not been manipulated for a third period of time (e.g., 10 seconds), or any combination of these. Additionally or alternatively, a vehicle condition can include an ambient temperature internal or external to the work vehicle being within a predetermined range of temperatures, a hydraulic fluid temperature being with a predetermined range of temperatures, a fan speed being with a predetermined range of speeds, a battery voltage being with a predetermined range of voltages, or any combination of these.

Additionally or alternatively, a vehicle condition can include a pump outlet pressure exceeding a predetermined threshold, a boom pilot control pressure exceeding a predetermined threshold, an arm pilot control pressure exceeding a predetermined threshold, a swing pilot control pressure exceeding a predetermined threshold, a bucket pilot control pressure exceeding a predetermined threshold, a travel pilot control pressure exceeding a predetermined threshold, an attachment pilot control pressure exceeding a predetermined threshold, or any combination of these. In some examples, a vehicle condition can additionally or alternatively include a front pilot being operated, a pilot-shutoff lever being manipulated, or both. The work vehicle can determine that the low idle condition is met if any combination of vehicle conditions is satisfied.

In some examples, an engine condition can include a temperature of the engine being within a predetermined range of temperatures, an oil pressure (e.g., an engine oil pressure) being within a predetermined range of pressures, an engine coolant temperature being within a predetermined range of temperatures, a speed of the engine being within a predetermined range of speeds, a torque amount being within a predetermined range of torques, or any combination of these. An engine condition can additionally or alternatively include the engine being in a particular idle-mode state, a particular fueling mode, or both. In some examples, the work vehicle can determine that the low idle condition is met if any combination of engine conditions is satisfied.

In some examples, vehicle control unit 202 can determine that one or more vehicle conditions are met and transmit a signal to the engine control unit 212 indicating that the one or more vehicle conditions are met. The engine control unit 212 can receive the signal and, in response to the signal, determine if one or more of the engine conditions are met. In other examples, the engine control unit 212 can determine that one or more engine conditions are met and transmit a signal indicating that the one or more engine conditions are met to the vehicle control unit 202. The vehicle control unit 202 can receive the signal and, in response to the signal, determine if one or more of the vehicle conditions are met.

In some examples, if the work vehicle determines that the low idle condition is not met, the process can return to block 310 or block 304. Otherwise, the process can continue to block 320.

In block 320, the work vehicle enters (or stays in) the low idle mode. In some examples, the vehicle control unit 202 can change a speed of the engine to a low idle speed in response to entering the low idle mode. For example, the vehicle control unit 202 can transmit a signal to the engine control unit 212 configured to cause the engine control unit 212 to change the speed of the engine to the low idle speed. In some examples, the low idle speed can be between 500 rpm and 900 rpm.

In some examples, the work vehicle can continuously check to determine if the low idle condition is still met. For example, the vehicle control unit 202 can continuously monitor the vehicle conditions to determine if the vehicle conditions are still satisfied. The engine control unit 212 can additionally or alternatively continuously monitor the engine conditions to determine if the engine conditions are still satisfied. If the vehicle conditions, the engine conditions, or both are still satisfied, the work vehicle can determine that the low idle condition is still met. If the work vehicle determines that the low idle condition is still met, the work vehicle can remain in the low idle mode. Otherwise, the process can return to block 304 and enter the normal operation mode, or to block 310 and determine if an idle condition is met.

In some examples, the different operational modes can reduce an amount of fuel consumed by, and improve the fuel efficiency of, the work vehicle. For example, the work vehicle can consume the most fuel when in the normal operation mode. The work vehicle can consume successively less fuel when in the elevated idle mode, the normal idle mode, and the low idle mode, respectively. The work vehicle can consume less fuel when in these modes because the engine speed is lower in these modes than during the normal operation mode. In some examples, reducing the fuel consumption of the work vehicle can reduce costs for the work vehicle owner or operator.

Although the above description included examples with the vehicle control unit 202 performing certain functions and the engine control unit 212 performing other functions, this is for illustrative purposes only. In some examples, the vehicle control unit 202 can perform some or all of the functions of engine control unit 212. In other examples, the engine control unit 212 can perform some or all of the functions of vehicle control unit 202.

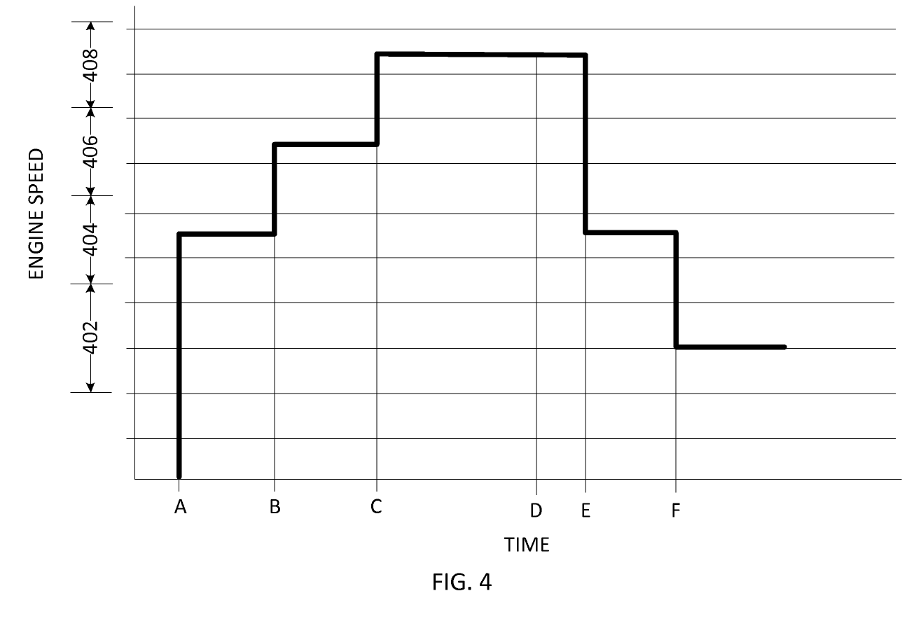

FIG. 4 is a graph of an example of an engine speed of a work vehicle over a period of time according to some aspects. In FIG. 4, at time 0, the engine is turned off. Thus, the engine speed is 0 rpm.

At time A, the engine is turned on and the work vehicle enters a normal idle mode, in which the engine speed is increased to within a normal-idle speed range 404. The work vehicle can remain in the normal idle mode until time B.

At time B, the work vehicle can enter an elevated idle mode, in which the engine speed is increased to within an elevated-idle speed range 406. The work vehicle can remain in the elevated idle mode until time C.

At time C, the work vehicle can enter a normal operation mode, in which the engine speed is increased to within a normal-operation speed range 408. While in the normal operation mode, the work vehicle can perform various tasks or jobs. For example, the work vehicle can used to dig trenches or holes, handle materials, demolish structures, or cut through materials. The work vehicle can remain in the normal operation mode until time E.

Between times D and E, a work vehicle operator may not use the work vehicle to perform a work function. Thus, the work vehicle may sit idle between times D and E. The work vehicle can reenter the normal idle mode at time E in response to the passage of time (e.g., 150 seconds) between times D and E. While in the normal idle mode, the engine speed can decrease to within the normal-idle speed range 404. The work vehicle can remain in the normal idle mode until time F. In other examples, the work vehicle can return to the normal operation mode (and the engine speed can increase back to within the normal-operation speed range 408) in response to detecting a manipulation of an input device or another condition indicating use of the work machine by an operator.

At time F, the work vehicle can enter a low idle mode, in which the engine speed is decreased to within a low-idle speed range 402. The work vehicle can enter the low idle mode at time G in response to detecting that one or more low idle conditions are met. For example, the work vehicle can enter the low idle mode in response to a vehicle control unit detecting one or more particular vehicle conditions and an engine control unit detecting one or more particular engine conditions. In some examples, the work vehicle can remain in the low idle mode until the work vehicle is turned off. In other examples, the work vehicle can return to the normal operation mode in response to detecting a manipulation of an input device or another condition indicating use of the work machine by an operator.

The example depicted in FIG. 4 is for illustrative purposes only. Any sequence and combination of the normal operation mode, elevated idle mode, normal idle mode, and low idle mode, occurring over any time intervals, is possible. Further, the engine speed ranges depicted for each of the modes are for illustrative purposes only. In other examples, the elevated idle mode, normal operation mode, normal idle mode, and/or low idle mode can cause the engine speed to change to within other ranges. For example, the low idle mode can cause the engine speed to change to within speed range 404. Additionally, although FIG. 4 depicts changes in engine speed as substantially instantaneous (e.g., as a step function), in some examples, the engine speed can be gradually increased or decreased over time. For example, at time A, the speed may increase gradually from 0 rpm to within normal-idle speed range 404.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. An excavator comprising:
an engine;
a first sensor configured to detect a vehicle characteristic and transmit a first sensor signal associated with the vehicle characteristic;
a second sensor configured to detect an engine characteristic and transmit a second sensor signal associated with the engine characteristic;
a control circuit positioned in the excavator for:
receiving the first sensor signal from the first sensor and the second sensor signal from the second sensor;
determining the vehicle characteristic based on the first sensor signal and the engine characteristic based on the second sensor signal;
determining that at least one vehicle condition of a plurality of vehicle conditions is satisfied based on the vehicle characteristic, the plurality of vehicle conditions comprising: an input device not being manipulated for a period of time, an ambient temperature of an environment within the excavator being with a first range of temperatures, another ambient temperature of another environment external to the excavator being within a second range of temperatures, a fan speed being with a first range of speeds, and a power source voltage being within a range of voltages;
determining that at least one engine condition of a plurality of engine conditions is satisfied based on the engine characteristic, the plurality of engine conditions comprising: an engine temperature being within a third range of temperatures, an engine coolant temperature being within a fourth range of temperatures, and an engine speed being with a second range of speeds; and
transmitting a signal configured to cause the excavator to reduce a speed of the engine to a low idle engine speed.

2. The excavator of claim 1, wherein the control circuit is further positioned for:
determining that at least two vehicle conditions of the plurality of vehicle conditions are satisfied;
determining that at least two engine conditions of the plurality of engine conditions are satisfied; and
transmitting the signal configured to cause the excavator to reduce the speed of the engine to the low idle engine speed in response to determining that the at least two vehicle conditions are satisfied and the at least two engine conditions are satisfied.

3. The excavator of claim 2, wherein the low idle engine speed is between 500 revolutions per minute (rpm) and 900 rpm.

4. The excavator of claim 3, wherein the control circuit comprises a vehicle control circuit and a separate engine control circuit;
wherein the vehicle control circuit is positioned in the excavator for:
receiving the first sensor signal from the first sensor,
determining the vehicle characteristic based on the first sensor signal, and
determining that the at least one vehicle condition of the plurality of vehicle conditions is satisfied based on the vehicle characteristic; and
wherein the engine control circuit is positioned in the excavator for:
receiving the second sensor signal from the second sensor,
determining the engine characteristic based on the second sensor signal, and
determining that the at least one engine condition of the plurality of engine conditions is satisfied based on the engine characteristic.

5. The excavator of claim 1, wherein the control circuit is further positioned in the excavator for:
prior to determining that the at least one vehicle condition is satisfied and that the at least one engine condition is satisfied:
determining that the input device has not been manipulated for a time period; and
in response to determining that the input device has not been manipulated for the time period, transmitting another signal configured to cause the excavator to reduce the speed of the engine to a normal idle speed.

6. The excavator of claim 5, wherein the normal idle speed is between 800 rpm and 1500 rpm.

7. The excavator of claim 1, wherein the control circuit is further positioned in the excavator for:
in response to a passage of a predetermined period of time:
determining that the at least one vehicle condition is no longer satisfied or that the at least one engine condition is no longer satisfied and responsively increasing the speed of the engine to a normal operation speed between 1700 rpm and 2200 rpm.

8. A method for controlling an engine speed of an excavator, the method comprising:
receiving a first sensor signal from a first sensor, the first sensor signal indicating a vehicle characteristic of the excavator;
determining that at least one vehicle condition of a plurality of vehicle conditions is satisfied based on the vehicle characteristic, the plurality of vehicle conditions comprising: an input device not being manipulated for a period of time, an ambient temperature of an environment within the excavator being with a first range of temperatures, another ambient temperature of another environment external to the excavator being within a second range of temperatures, a fan speed being with a first range of speeds, and a power source voltage being within a range of voltages;
receiving a second sensor signal from a second sensor, the second sensor signal indicating an engine characteristic of the excavator;
determining that at least one engine condition of a plurality of engine conditions is satisfied based on the engine characteristic, the plurality of engine conditions comprising: an engine temperature being within a third range of temperatures, an engine coolant temperature being within a fourth range of temperatures, and the engine speed being with a second range of speeds; and
transmitting a signal configured to cause the excavator to reduce the engine speed to a low idle engine speed.

9. The method of claim 8, further comprising:
determining that at least two vehicle conditions of the plurality of vehicle conditions are satisfied;
determining that at least two engine conditions of the plurality of engine conditions are satisfied; and
transmitting the signal configured to cause the excavator to reduce the engine speed to the low idle engine speed in response to determining that the at least two vehicle conditions are satisfied and the at least two engine conditions are satisfied.

10. The method of claim 8, wherein the plurality of vehicle conditions further comprises a pump outlet pressure exceeding a first threshold, an arm pilot control pressure exceeding a second threshold, a swing pilot control pressure exceeding a third threshold, and a bucket pilot control pressure exceeding a fourth threshold, a travel pilot control pressure exceeding a fifth threshold, and an attachment pilot control pressure exceeding a sixth threshold.

11. The method of claim 10, further comprising:
determining that all of the plurality of vehicle conditions are satisfied;
determining that all of the plurality of engine conditions are satisfied; and
transmitting the signal configured to cause the excavator to reduce the engine speed to the low idle engine speed in response to determining that all of the plurality of vehicle conditions are satisfied and all of the plurality of engine conditions are satisfied.

12. The method of claim 8, wherein a vehicle control unit of the excavator receives the first sensor signal from the first sensor and determines that the at least one vehicle condition is satisfied; and
wherein a separate engine control unit of the excavator receives the second sensor signal from the second sensor and determines that the at least one engine condition is satisfied.

13. The method of claim 8, further comprising:
prior to determining that the at least one vehicle condition is satisfied and that the at least one engine condition is satisfied:
determining that the input device has not been manipulated for a time period; and
in response to determining that the input device has not been manipulated for the time period, transmitting another signal configured to cause the excavator to reduce the engine speed to a normal idle speed.

14. The method of claim 8, further comprising:
in response to a passage of a predetermined period of time:
determining that the at least one vehicle condition is no longer satisfied or that the at least one engine condition is no longer satisfied; and
increasing the engine speed to a normal operation speed.

15. An engine speed control system for use in an excavator, the engine speed control system comprising:
a vehicle control circuit for:
determining that at least one vehicle condition of a plurality of vehicle conditions is satisfied, the plurality of vehicle conditions comprising: an input device not being manipulated for a period of time, an ambient temperature of an environment within the excavator being with a first range of temperatures, another ambient temperature of another environment external to the excavator being within a second range of temperatures, a fan speed being with a first range of speeds, and a power source voltage being within a range of voltages, and
transmitting a first signal to indicating that the at least one vehicle condition is satisfied; and
an engine control circuit for receiving the first signal and, in response to the first signal:
determining that at least one engine condition of a plurality of engine conditions is satisfied, the plurality of engine conditions comprising: an engine temperature being within a third range of temperatures, an engine coolant temperature being within a fourth range of temperatures, and an engine speed being with a second range of speeds; and
transmitting a second signal configured to cause the excavator to reduce the engine speed to a low idle engine speed.

16. The engine speed control system of claim 15, further comprising:
a first sensor configured to detect a vehicle characteristic of the excavator and transmit a first sensor signal associated with the vehicle characteristic; and
a second sensor configured to detect an engine characteristic of the excavator and transmit a second sensor signal associated with the engine characteristic;
wherein the vehicle control circuit is for:
receiving the first sensor signal from the first sensor,
determining the vehicle characteristic based on the first sensor signal, and
determining that at least two vehicle conditions of the plurality of vehicle conditions are satisfied based at least in part on the vehicle characteristic; and
wherein the engine control circuit is for:
receiving the second sensor signal from the second sensor,
determining the engine characteristic based on the second sensor signal,
determining that at least two engine conditions of the plurality of engine conditions are satisfied based at least in part on the engine characteristic, and
transmitting the second signal in response to determining that the at least two vehicle conditions are satisfied and the at least two engine conditions are satisfied.

17. The engine speed control system of claim 16, wherein the plurality of vehicle conditions further comprises a pump outlet pressure exceeding a first threshold, an arm pilot control pressure exceeding a second threshold, a swing pilot control pressure exceeding a third threshold, and a bucket pilot control pressure exceeding a fourth threshold, a travel pilot control pressure exceeding a fifth threshold, and an attachment pilot control pressure exceeding a sixth threshold.

18. The engine speed control system of claim 16, wherein:
the vehicle control circuit is further for determining that all of the plurality of vehicle conditions are satisfied and transmitting a third signal indicating that all of the plurality of vehicle conditions are satisfied; and
the engine control circuit is further for receiving the third signal and, in response to the third signal:
determining that all of the plurality of engine conditions are satisfied; and
transmitting the second signal configured to cause the excavator to reduce the engine speed to the low idle engine speed.

19. The engine speed control system of claim 15, wherein the vehicle control circuit or the engine control circuit is further for:
determining that the input device has not been manipulated for a time period; and
in response to determining that the input device has not been manipulated for the time period, transmitting a third signal configured to cause the excavator to reduce the engine speed to a normal idle speed.

20. The engine speed control system of claim 15, wherein the vehicle control circuit or the engine control circuit is further for:
in response to a passage of a predetermined period of time:
determining that the at least one vehicle condition is no longer satisfied or that the at least one engine condition is no longer satisfied; and
increasing the engine speed to a normal operation speed.
